(19) United States
(12) Patent Application Publication
(10) Pub. No.: US 2002/0015037 A1
(43) Pub. Date: Feb. 7, 2002

(54) Human-machine interface apparatus

(76) Inventors: Roger Kenneth Moore, West Malvern (GB); Robert William Series, Malvern (GB)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/843,117

(22) Filed: Apr. 26, 2001

(30) Foreign Application Priority Data
Apr. 26, 2000 (GB) 0010034.7

(51) Int. Cl. G09G 5/00; G06T 15/00

(52) U.S. Cl. 345/419; 345/156

(57) ABSTRACT

A human-machine interface apparatus for providing an output from a computer. The human-machine interface apparatus comprises a three-dimensional form shaped to represent a communications agent, the three-dimensional form having a display surface, an input interface for accepting image data from a computer, a display apparatus for displaying an image with which a user can engage on the display surface corresponding to the input image data, an input apparatus for receiving non-manual inputs from a user who is engaging with an image on the display apparatus, and an output interface for providing to a computer data derived from inputs received by the input apparatus.

### DESCRIPTION

This invention relates to human-machine interface apparatus, particularly a human-machine interface for providing an output from a computer.

There are many interfaces by which information can be output from and input into a computer. By far the most usual input device is the computer monitor, a computer screen upon which images can be displayed, controlled by a program within the computer. For data input, the most usual device is the keyboard and, in many cases, an associated pointing device (e.g. a mouse). While conventional computer interface devices proved to be adequate when computers were called upon to undertake a limited range of tasks in specific, controlled environments, they do not provide a natural interface and can be hard to use in some of the increasing range of applications to which computers are being applied.

Provision of an automatic speech recognition systems for use in computers is a more natural way to provide an input interface than a manual input such as a keyboard or a mouse. Automatic speech recognition technology can now go a long way towards completely replacing conventional manual input interfaces. However, it can address only the input side of a bi-directional computer interface.

It is becoming increasingly common for a computer system to be used in situations in which a group of people may be using a single display. For example in a meeting a number of people may be seated round a table with one position occupied by a computer equipped with a display screen and speech recognition and synthesis system so as to provide a bi-directional speech interface. Each speaker may have an individual microphone connected to the recognition system so that the system knows which person is speaking at any instant. To give the system a more friendly character the screen may display a moving image of a three dimensional human being or human head; a so-called avatar or talking head. At present such images are inevitably displayed on a flat display and so they are two dimensional and give only an illusion of three-dimensional depth. At any instant the speech recognition system may detect who is the principle speaker by analysis of which microphone is receiving the loudest signal (diversity switching). It would be desirable if the direction of gaze of the avatar could change so as to track the principle speaker. The speaker then knows that the system is listening to him. Unfortunately it is a well-known property of two dimensional facial images, that no matter what the view angle, all viewers see the eyes pointing in the same direction. For example if the current speaker is positioned to the left of the avatar and the avatar's eyes point left, all speakers will see the direction of gaze as being to their left. In contrast, with a human in the place of the avatar, the speaker to the left would see the gaze as being directed at him, while the other viewers would see the eyes point to the left in differing degrees. The perceived direction of gaze of a head displayed on a flat screen is ambiguous, which can restrict the ability for the display to convince a user that the head's gaze is direction in a specific direction, which can give the impression of its being somewhat uninvolved with a user.

An alternative known human-machine interface is a holographic display. Such a display can provide a three-dimensional image of a human head. However, it is extremely difficult to provide a realistic moving image controlled by a computer, let alone to provide it cheaply enough to be used by the general public.

There is accordingly a need for a more realistic human-machine interface to facilitate more natural interaction between a user and a computer.

According to the invention there is provided human-machine interface apparatus, comprising a three-dimensional form shaped to represent a communications agent, the three-dimensional form having a display surface, an input interface for accepting image data from a computer, a display apparatus for displaying an image with which a user can engage on the display surface corresponding to the input image data, an input apparatus for receiving non-manual inputs from a user who is engaging with an image on the display apparatus, and an output interface for providing to a computer data derived from inputs received by the input apparatus.

Such apparatus can provide a bi-directional interface with which a user can interact in a natural manner. It has been found that a user's ability to engage with an interface is particularly desirable because engagement is an essential part of communication between humans. By using a three-dimensional form a solid image may be provided without the need for holography. A simple solid form with no movement would not provide a realistic model. However, by displaying synthetic images on the display surface it is possible to change the image data and accordingly to display moving images on the communications agent.

At least part of the three-dimensional form may be shaped (at least partially) in the form of a head. It may include an upper (or an entire) body. It may, for example, include a human head or a representation of some other communication agent. However, it might alternatively (at least partially) be shaped as an animal's head, a robotic head, a fanciful or abstract representation that has features suggestive of a face with which a user can engage, or any form which a human may wish to interact with or to anthropomorphise. In applications where the interface is intended for use by children, for example, fanciful forms such as a talking space ship with eyes or more conventional forms may be appropriate. Alternatively, the three-dimensional form might be shaped in the form of part of a head, for instance as a front face or perhaps just as an eyeball.

The display surface may have an eye region and the display apparatus may be arranged to display on the eye region an image of an eye having a gaze direction controllable by the input. In this way the apparent gaze direction of the communications agent may be varied under the control of the input, and this can enhance its ability to engage with a user. Advantageously, from the point of view of realism, the eye region may include a convex surface that is representative of an eyeball. Alternatively, the eye region may include a concave surface that gives the impression of being a convex surface. The impression of being a convex surface might be achieved by illuminating the concave surface in a particular manner. By careful manipulation of parameters to the synthetic image displayed, the gaze direction on a three-dimensional form may be controlled and a unique gaze direction may be realised. Only observers in one orientation will perceive the gaze as being directed at them. The advantage of engaging with a particular observer is illustrated by the following example. A communications agent is provided as a “guide” in a museum. A group of children approach the communications agent, and one child asks a question. The communications agent takes the child's voice as a cue to control the direction of its gaze, thereby apparently directing its reply to that one child.

Embodiments of the invention may permit a representation of a head to move its eyes, lick its lips, or perform other normal human functions. Emotion may thus be more conveyed.

The input interface may include an electrical input or an optical input. The input interface may preferably include a connector according to a computer interface standard so that the human-machine interface may be readily connected to a computer.

The output interface most typically includes at least one electrical output connector. Each such output connector may be in accordance with one or more computer interface standard.

The display apparatus may include a projector or projectors for projecting a image onto the display surface. The image may be projected from within or from outwith the three-dimensional form (or both). The input for accepting image data may be on the projector.

Alternatively, the head may itself carry a display unit. The display unit may be constituted as a directly viewed electronically modulated layer. The display unit might be a flexible liquid crystal display, for example a liquid crystal on a plastic substrate. Alternatively, the display unit might be an electrochromic, solid state or plasma display or a phosphor lining in a hollow head with a CRT exciter.

A human-machine interface may be enhanced by providing a means for producing sound. Preferably, the sound-producing means may be a loudspeaker mounted in the vicinity of a mouth formation of the three-dimensional form. The display surface may form part of the loudspeaker; it may form the resonant panel of a bending wave loudspeaker, such as that described in WO97/09842 to New Transducers Limited.

A further enhancement may be provided by animation of the image of the lips in synchronisation with the sound output, or by mechanical movement of the lips, jaw or other parts of the head, or even by movement of the whole head.

The input apparatus of embodiments of the typically include a microphone system (which can be considered to be a general audio input device). Advantageously, the image may be modified in response to signals received from the microphone system.

Most advantageously, a microphone system of the last-preceding paragraph is of a type that has directional sensitivity, and may be a beam-steering microphone array, such as might include a plurality of microphones. An advantage of a beam-steering microphone array is that it may have a directional sensitivity that can be controlled electronically without the need to provide moving mechanical components.

Embodiments according to the last-preceding paragraph may be included or be associated with a control system that is operative to cause the sensitivity of the microphone to be directed towards a user who is engaging with the image on the display surface. In particular, in embodiments that generate a display that gives a perception of a gaze direction, the system may be operative to cause the sensitivity of the microphone system to be directed generally in the gaze direction. (The gaze direction and the sensitivity of the microphone system may be fixed or may move.) This can provide a user with (possibly subliminal) information that will help ensure that they engage with the interface in a manner most likely to enable their voice to be effectively detected by the microphone system.

In a further enhancement, the control system may be operative to determine the position of a user and direct the gaze and direction of sensitivity of the microphone system towards the user. The position of the user might, for example, be determined (entirely or in part) by processing an input from the microphone system.

The input apparatus might include an optical input device. That device may be a video camera, or may be a simple detector for the presence or absence of light. Advantageously, the image may be modified in response to signals received from the optical input device. In cases in which such embodiments are provided in accordance with the features set forth in either sentence of the last-preceding paragraph, the position of the user might be determined (entirely or in part) by processing an input from the optical input device. The optical input device may be sensitive to visible light. It may additionally or alternatively be sensitive to light in other frequencies, such as infra-red, or respond to changes over time of the sensed image. An advantage of modifying the image may be illustrated by reference to the example described above of a communications agent that acts as a museum “guide” for a group of children. After the communications agent has initiated engagement with one child by directing its gaze towards him, an improvement in the child's interaction with the communications agent may be gained by having the gaze follow the child as he moves around the museum. The communications agent might track the child in response to signals received from the optical input device. Alternatively or in addition, the communications agent might track the child in response to signals received from the microphone system.

An interface apparatus embodying the invention may include, or be in association with, an automatic speech recognition system. A user can interact with such a system by speaking to it while engaging with e.g. a gaze in the displayed image. An interface apparatus embodying the invention may include, or be provided in association with, a speech synthesis system. When a speech recognition and synthesis system are provided in combination, a user may hold a virtual two-way conversation through the interface apparatus. (For example the speech recognition and/or synthesis system could be a software system executing on a computer in embodiments of the second aspect of the invention, or on another data processing system.)

A separate sound input for the interface may be provided for inputting sound to the head or alternatively the input for inputting image data may be used for inputting sound as well.

According to a second aspect of the invention, there is provided a computer system comprising a computer and a human-machine interface as described above.

The computer system may include automatic speech recognition software and/or hardware that can receive and process audio signals derived from the interface apparatus.

The computer system may include speech synthesis software and/or hardware for synthesising audio-visual speech patterns. Such speech may be supplied to a loudspeaker and/or to the interface apparatus.

The computer system may comprise an image output on the computer connected to the image input on the human-machine interface apparatus, and image processing software executing on the computer for generating a sequence of images and outputting them on the image output so that the display means displays the sequence of images on the model head.

In most cases, operation of the computer system can be controlled by or is reactive to inputs received from the interface apparatus.

A specific embodiment of the invention will now be described in detail, by way of example, and with reference to the accompanying drawings in which:

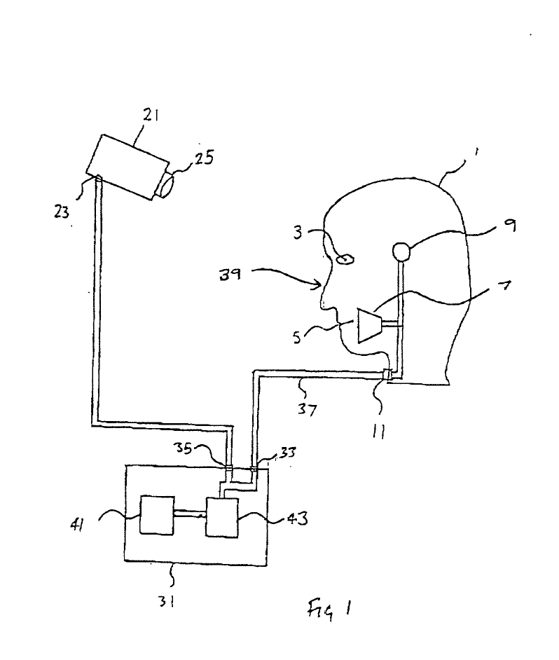

FIG. 1 shows a computer system incorporating a human-machine interface apparatus according to the invention;

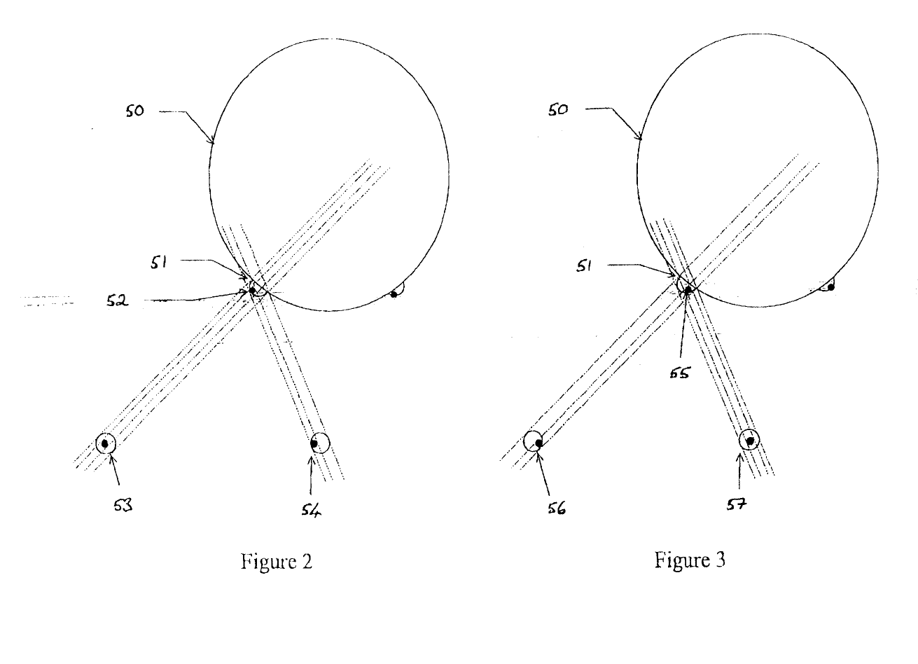

FIGS. 2 and 3 illustrate the operation of a human-machine interface apparatus according to the invention; and

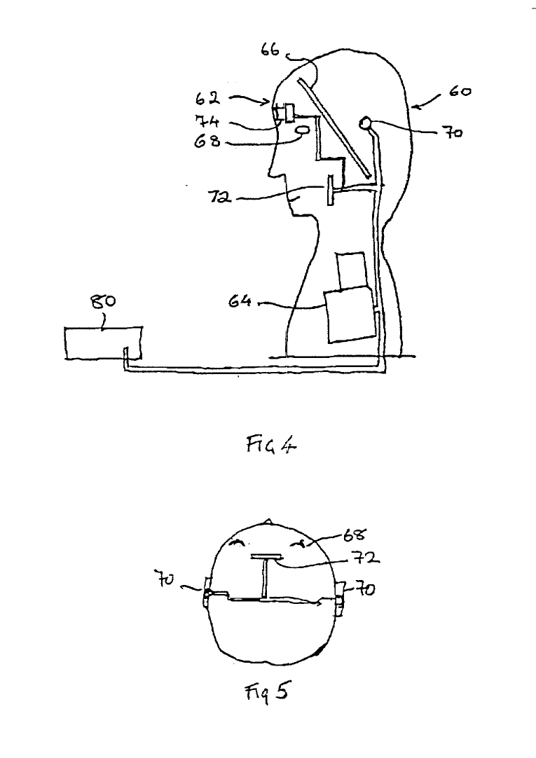

FIGS. 4 and 5 show an alternative configuration of a human-machine interface suitable for use in a computer system embodying the invention.

A computer system having a human-machine interface being an embodiment of the invention includes a three-dimensional form being a three-dimensional model of a human head 1. The model has formations that represent eyes 3 and a mouth 5. Within the head, there is provided a loudspeaker 7 in the vicinity of the mouth 5 and a microphone 9. The formations 3 that represent the eyes are formed as a convex region of the display surface, shaped to resemble the shape of a human eyeball.

The interface further comprises a projector 21 that has a computer input interface 23. A front surface of the head, corresponding to a face region, constitutes a display surface 39. The projector 21 has a lens 25 for projecting an image on to the display surface 39, the projected image being defined by image data input at the computer input interface 23.

The loudspeaker 7, the microphone 9 and the projector 21 are electrically connected to a computer input and output interface 11.

The system further includes a computer 31 that has connectors 33,35 connected to the interfaces 11,23 using a conventional computer interface bus 37. The computer includes a memory 41 and a data processing unit 43.

In operation, a speech synthesis computer program is loaded into the memory 41 for execution to control the computer to provide a synthesised speech output. This output is used to provide signals to drive the loudspeaker 7. Likewise an automatic speech recognition program is provided in the computer memory 41 to process sounds picked up by the microphone 9 and convert them into operating instructions that are processed by an application or control operation of the computer.

Also, an image display program is provided in the computer memory 41 to control the central processing unit 43 to output a sequence of images to one of the connectors 33,35 to transmit the sequence of images down the computer bus 37 to the projector 21. In use, the image display program causes the projector to generate a sequence of changing images onto the display surface of the model to simulate a moving human head.

The operation of the interface apparatus is illustrated by means of FIG. 2, in which the computer has engaged with a user positioned to the left, and FIG. 3, in which the engagement is to the right. A computer generated image of a face is projected onto the mannequin head which is shown in cross section at 50. The computer generated image of the eye is projected onto the bulging eyeball 51. The position of the pupil of the eye is computed and projected such that it is positioned at 52 as shown in FIG. 2. The gaze direction is to the left. An observer to the left sees the iris centred in the eyeball as shown at 53. An observer to the right sees the pupil gazing left as shown at 54.

If the computer now engages with a user positioned to the right, as shown in FIG. 3, the image of the eye is recomputed and the position of the pupil now projected as shown at 55. An observer to the left sees the pupil gazing to the right, as shown at 56, while an observer to the right sees the iris centred in the eyeball and directed to him, as shown at 57.

In a second embodiment of the invention, the three-dimensional form of the human-machine interface is a model 60 shaped to represent the upper part of a human torso and human head. The model is hollow and is formed from a translucent material. An outer surface 62 of the model in the region of the face constitutes a display surface of the model. As with the first embodiment, the face includes eye-regions 68 that have a convex configuration, in imitation of the shape of a human eyeball, upon which the image of an eye is projected by the projector, and a bending-wave loudspeaker 72 that can be used to generate an audio output. As in the case of the first embodiment, the human-machine interface acts as an interface to a computer 80.

A projector 64 is arranged to project an image within the model 60, the image being directed by a mirror 66 to impinge on the display surface within the model. Being translucent, the image is visible on the display surface externally of the model.

Within the model of this embodiment, there is provided a microphone system comprising two microphones 70 that implement a beam-steering microphone array. The direction of a signal received by the two microphones may, for example, be determined by analysing which of the two microphones is receiving the loudest signal (diversity switching). Operation of the array is controlled by software executing on the computer. As is well-known, the signals received by the two microphones can be combined with suitable phase shifts to effectively control the direction of sensitivity of the array. Various techniques have been proposed to enable the beam of a beam-steering microphone array to track a sound source, such as a human voice, moving in the field of sensitivity of the array.

The interface also includes an optical input device, in this case being a charge-coupled device (CCD) camera 74. Signals from the CCD camera 74 are fed through the computer output interface to the computer 80.

In this invention, analysis of the input received by the microphone array 70 derives directional information that specifies the direction of a sound source identified as speech within the field of sensitivity of the microphone array 70. This information is then used as an input parameter for the image display program that specifies the gaze direction that is to be simulated by the image display program, whereby the gaze is apparently directed towards the source of speech. Further directional information may be obtained by analysis of the image received from the CCD camera, for example, by applying processing to identify features indicative of the presence of a human face.

Input from the microphone array 70 is processed by an automatic speech recognition system. The speech recognition system can cause the computer to perform an essentially arbitrary range of functions. As a simple example, the functions might include control of the computer or other apparatus. As a more complex example, the speech recognition system might provide input to a complex software system such as an expert system or artificial intelligence system. Such a system can provide output in the form of parameters that can be used to drive the speech synthesis system. In this way, the embodiment provides a bi-directional human-machine interface through which a user can provide input to a computer in the form of spoken words, receive output in the form of synthetic speech, and apparently engage in eye contact. As will be appreciated, this can provide a fully functional interface to a computer that implements the principle elements of a human conversation.

The complexity of interaction with a human-machine interface of this type is likely to be limited only by the complexity of processing that can be performed on the data received by the user. As the power of computer systems increases, so can the complexity of interaction, and this is likely to be further enhanced by developments in artificial-intelligence and similar systems. For example, systems embodying the invention might implement a virtual person, such as a virtual personal assistant.

The invention is not restricted to the above embodiments. Although the form in the above embodiments represent a human head or part of a human body, the form may represent any communications agent, such as human upper body and head, an animal's head, an abstract from a loosely representing a head, or any form with which a human may wish to interact, in applications for children, for example, fanciful forms such as a talking space ship with eyes or more conventional forms may be appropriate.

1. Human-machine interface apparatus, comprising
a three-dimensional form shaped to represent a communications agent, the three-dimensional form having a display surface,
an input interface for accepting image data from a computer,
a display apparatus for displaying an image with which a user can engage on the display surface corresponding to the input image data,
an input apparatus for receiving non-manual inputs from a user who is engaging with an image on the display apparatus, and
an output interface for providing to a computer data derived from inputs received by the input apparatus.

2. Human-machine interface apparatus according to claim 1 in which at least part of the three-dimensional form is shaped in the form of a head.

3. A human-machine interface according to claim 2 wherein the head is (at least partially) shaped in the form of a human head.

4. A human-machine interface according to claim 2 in which the head is (at least partially) shaped in the form of an animal head, a robotic head, or a fanciful representation that has features suggestive of a face.

5. A human-machine interface according to claim 1 in which the display surface has an eye region and the display apparatus is arranged to display on the eye region an image of an eye having a gaze direction controllable by the input.

6. A human-machine interface according to claim 5 in which the eye region includes a convex surface representative of an eyeball.

7. A human-machine interface according to claim 1 in which the input interface includes an electrical input or an optical input.

8. A human-machine interface according to claim 7 in which the input interface includes a connector according to a computer interface standard so that the human-machine interface may be readily connected to a computer.

9. A human-machine interface according to claim 1 in which the output interface includes at least one electrical output connector.

10. A human-machine interface according to claim 9 in which the or each such output connector is in accordance with one or more computer interface standard.

11. A human-machine interface according to claim 1 wherein the display apparatus comprises at least one projector for projecting an image on to the display surface.

12. A human-machine interface according to claim 1 in which the display apparatus comprises a display unit on the display surface.

13. A human-machine interface according to claim 12 in which the display unit comprises a directly viewed electronically modulated layer such as a flexible liquid crystal display.

14. A human-machine interface according to claim 1 comprising a loudspeaker associated with the three-dimensional form.

15. A human-machine interface according to claim 14 wherein the loudspeaker is mounted in the vicinity of a mouth formation of the three-dimensional form.

16. A human-machine interface according to claim 14, wherein the image is modified in synchronisation with an output of the loudspeaker.

17. A human-machine interface according to claim 1 further comprising a microphone system for picking up speech or other sounds.

18. A human-machine interface according to claim 17 in which the microphone system comprises a plurality of microphones.

19. A human-machine interface according to claim 17 in which the image is modified in response to signals received from the microphone system.

20. A human-machine interface according to claim 17 in which the microphone system is of a type that has directional sensitivity.

21. A human-machine interface according to claim 20 in which the microphone system is a beam-steering microphone array that includes a plurality of microphones.

22. A human-machine interface according to claim 21 that includes or is associated with a control system that is operative to cause the sensitivity of the microphone to be directed towards a user who is engaging with the image on the display surface.

23. A human-machine interface according to claim 22 as dependent from claim 5 in which the system is operative to cause the sensitivity of the microphone system to be directed generally in the gaze direction.

24. A human-machine interface according to claim 23 in which the control system is operative to determine the position of a user and direct the gaze and direction of sensitivity of the microphone system towards the user.

25. A human-machine interface according to claim 24 in which the control system determines the position of the user by processing an input from the microphone system.

26. A human-machine interface according to claim 1 including an optical input device.

27. A human-machine interface according to claim 26 in which the image is modified in response to signals received from the optical input device.

28. A human-machine interface according to claim 26 in which the optical input device is sensitive to visible light.

29. A human-machine interface according to claim 26 in which the optical input device is sensitive to infra-red light.

30. A human-machine interface according to claim 26, in which the optical input device is responsive to changes over time in an image sensed by the optical input device.

31. A human-machine interface according to claim 30 in which the optical input device includes a video camera.

32. A human-machine interface according to claim 26 in which the position of the user is determined (entirely or in part) by processing an input from the optical input device.

33. A human-machine interface according to claim 1 including, or being in association with, an automatic speech recognition system.

34. A human-machine interface according to claim 1 including, or being in association with, a speech synthesis system.

35. A computer system comprising
a three-dimensional form shaped to represent a communications agent, the three-dimensional form having a display surface,
an input interface for accepting image data from a computer,
a display apparatus for displaying an image with which a user can engage on the display surface corresponding to the input image data,
an input apparatus for receiving non-manual inputs from a user who is engaging with an image on the display apparatus,
an output interface for providing to a computer data derived from inputs received by the input apparatus, and
a computer.

36. A computer system according to claim 35 which includes automatic speech recognition software and/or hardware that can receive and process audio signals derived from the interface apparatus.

37. A computer system according to claim 35 further comprising speech synthesis software and/or hardware for synthesising speech.

38. A computer system according to claim 35 further comprising an image output on the computer connected to the image input on the human-machine interface apparatus, and image display software on the computer for generating a sequence of images and outputting them on the image output so that the display apparatus displays the sequence of images on the display surface.

39. A computer system according to claim 35, the operation of which can be controlled by or is reactive to inputs received from the interface apparatus.
